(19) United States
(12) Patent Application Publication
(10) Pub. No.: US 2026/0299494 A1
(43) Pub. Date: Oct. 1, 2026

(54) IMAGE FORMING APPARATUS

(71) Applicant: BROTHER KOGYO KABUSHIKI KAISHA, Nagoya (JP)

(72) Inventors: Ayaka Mori, Nagoya (JP); Masaki Ochiai, Ichinomiya (JP)

(73) Assignee: BROTHER KOGYO KABUSHIKI KAISHA, Nagoya (JP)

(21) Appl. No.: 19/562,308

(22) Filed: Mar. 10, 2026

(30) Foreign Application Priority Data
Mar. 25, 2025 (JP) 2025-049615

(51) Int. Cl. G03G 15/00; G03G 15/16; G03G 15/20; G03G 21/16

(52) U.S. Cl. CPC G03G 15/657; G03G 15/167; G03G 15/2017; G03G 15/2064; G03G 15/5008; G03G 15/757; G03G 21/1647; G03G 2215/00603

(57) ABSTRACT

An image forming apparatus includes an image carrier, a transfer roller, a heating rotator, a pressure rotator, a chute, a motor, a rotator, and a link. The image carrier carries a toner image. The transfer roller transfers the toner image carried on the image carrier onto a sheet. The chute is movable between a first chute position at which the chute guides the sheet toward a fixing position, and a second chute position. The rotator receives a driving force from the motor and rotates. The link is movable in a first direction, in conjunction with rotation of the rotator, between a first position at which the link locates the chute at the first chute position, and a second position at which the link locates the chute at the second chute position.

### REFERENCE TO RELATED APPLICATIONS

This application claims priority from Japanese Patent Application No. 2025-049615 filed on Mar. 25, 2025. The entire contents of the priority application are incorporated herein by reference.

### BACKGROUND ART

An image forming apparatus known in the art includes a chute that directs a sheet which has passed through a transfer position toward a fixing position. In such an image forming apparatus, the chute is movable between a first position and a second position located below the first position. The chute is moved between the first position and the second position by power from a solenoid actuator.

### SUMMARY

However, a large solenoid actuator is required to move the chute.

It is desirable to move the chute without using a large solenoid actuator.

In one aspect, an image forming apparatus according to the present disclosure includes an image carrier, a transfer roller, a heating rotator, a pressure rotator, a chute, a motor, a rotator, and a link.

The image carrier carries a toner image.

The transfer roller transfers the toner image carried on the image carrier onto a sheet at a transfer position at which the transfer roller nips the sheet in combination with the image carrier.

The heating rotator is located downstream of the transfer roller in a conveyance direction in which the sheet is conveyed. The heating rotator heats the sheet.

The pressure rotator applies pressure to the sheet at a fixing position at which the pressure rotator nips the sheet in combination with the heating rotator.

The chute is located between the transfer position and the fixing position in the conveyance direction, and on one side in a first direction transverse to the conveyance direction with respect to the sheet being conveyed from the transfer position toward the fixing position. The chute is movable between a first chute position at which the chute guides the sheet toward the fixing position, and a second chute position located on the one side in the first direction relative to the first chute position.

The rotator receives a driving force from the motor and rotates.

The link is movable in the first direction, in conjunction with rotation of the rotator, between a first position and a second position.

The first position is a position at which the link locates the chute at the first chute position.

The second position is a position at which the link locates the chute at the second chute position.

Since the image forming apparatus includes the rotator and the link, the chute can be moved by the motor. Accordingly, the chute can be moved without using a large solenoid actuator.

The link may be directly connected to the chute and configured to push the chute toward the one side and an opposite side in the first direction.

By the link being directly connected to the chute, the chute can be held by the link. As a result, large movement of the chute located at the first chute position or the second chute position can be suppressed.

The link may be directly connected to the rotator.

By the link being directly connected to the rotator, the number of parts can be reduced. Thus, the mechanism for moving the chute can be downsized.

The image forming apparatus may further include a drive mechanism that causes the rotator to rotate between a first phase and a second phase.

The first phase is a phase at which the rotator locates the link at the first position.

The second phase is a phase rotated 180 degrees from the first phase, and at which the rotator locates the link at the second position.

The drive mechanism may include an output gear configured to transmit the driving force from the motor to the rotator.

The rotator may have on a circumferential surface thereof a first toothless portion, a first gear teeth portion meshable with the output gear, a second toothless portion, and a second gear teeth portion meshable with the output gear.

The first toothless portion faces the output gear when the rotator is located at the first phase, and the second toothless portion faces the output gear when the rotator is located at the second phase.

Since the first toothless portion faces the output gear when the rotator is located at the first phase, the rotator can be stopped at the first phase. Since the second toothless portion faces the output gear when the rotator is located at the second phase, the rotator can be stopped at the second phase.

The drive mechanism may further include a lever, a solenoid actuator, and a first spring.

The lever stops the rotator at the first phase or the second phase upon engagement with the rotator. The lever allows rotation of the rotator upon disengagement therefrom.

The solenoid actuator moves the lever.

The first spring applies a rotational biasing force to the rotator located at the first phase or the second phase.

The rotator may be located above the chute.

A connection portion of the link and the rotator is located above a rotation axis of the rotator when the rotator is located at the first phase.

The connection portion of the link and the rotator is located below the rotation axis of the rotator when the rotator is located at the second phase.

The connection portion of the link and the rotator may be located above or below the rotation axis of the rotator. Thus, the link can be moved up and down in conjunction with the rotation of the rotator.

The chute may have a projection protruding in the widthwise direction, and the link may have a hole in which the projection is received.

The image forming apparatus may further include a second spring, and the hole may be an elongated hole.

The second spring biases the chute toward the first chute position.

The hole is long in the first direction.

Since the image forming apparatus includes the second spring and the hole is an elongated hole, the chute can be restrained from moving from the first chute position. The chute located in the first chute position can thereby stably guide a sheet toward the fixing position.

The lever may include a first arm and a second arm, and may be movable between a first lever position and a second lever position.

The first arm stops the rotator at the first phase upon engagement with the rotator.

The second arm stops the rotator at the second phase upon engagement with the rotator.

The first lever position is a position at which the first arm is engageable with the rotator and the second arm is not engageable with the rotator.

The second lever position is a position at which the second arm is engageable with the rotator and the first arm is not engageable with the rotator.

The solenoid actuator may be switchable to a first state that locates the lever at the first lever position, and to a second state that locates the lever at the second lever position.

The solenoid actuator is switchable to a first state that locates the lever at the first lever position, and to a second state that locates the lever at the second lever position. Accordingly, the position of the lever can be switched quickly by simply switching the solenoid actuator from one of the first state and the second state to the other of the first state and the second state.

The solenoid actuator may be switched from the first state to the second state in a state where the rotator is located at the first phase. The rotator thereby rotates by a biasing force of the first spring, causing the first gear teeth portion to mesh with the output gear. Then, the output gear transmits a driving force to the rotator to rotate the rotator toward the second phase. The rotator engages the second arm when the rotator reaches the second phase.

The solenoid actuator may be switched from the second state to the first state in a state where the rotator is located at the second phase. The rotator thereby rotates by a biasing force of the first spring, causing the second gear teeth portion to mesh with the output gear. Then, the output gear transmits a driving force to the rotator to rotate the rotator toward the first phase. The rotator engages the first arm when the rotator reaches the first phase.

The image carrier may be a photosensitive drum, the pressure rotator may be a pressure roller, and the motor may be a motor that drives the photosensitive drum and the pressure roller.

The motor is a motor for driving the photosensitive drum and the pressure roller. Accordingly, the chute can be moved using the motor for driving the photosensitive drum and the pressure roller. Thus, a dedicated motor for moving the chute can be dispensed with.

The output gear may be a gear that transmits the driving force from the motor to the pressure roller.

The output gear is a gear that transmits the driving force from the motor to the pressure roller. Accordingly, the rotator can be driven using the gear that transmits the driving force from the motor to the pressure roller. Thus, the number of parts of the drive mechanism can be reduced and the drive mechanism can be downsized.

The rotator may be aligned with the chute in the first direction, as viewed in the widthwise direction.

The rotator is aligned with the chute in the first direction, as viewed in the widthwise direction. The chute can thereby be efficiently pushed down or pulled up by the link in a configuration in which the link is directly connected to the chute.

The image forming apparatus may further include a controller.

The controller may switch the solenoid actuator from the first state to the second state after a leading edge of the sheet passes through the fixing position.

The controller switches the solenoid actuator from the first state to the second state after the leading edge of the sheet passes through the fixing position. Accordingly, the chute is located at the first chute position before the leading edge of the sheet enters the fixing position. The posture of the sheet entering the fixing position can thereby be kept at a proper posture by the chute. After the leading edge of the sheet passes through the fixing position, the chute moves to the second chute position. Accordingly, a space for the sheet to deflect toward the chute can be secured.

The controller may switch the solenoid actuator from the second state to the first state after a trailing edge of the sheet passes through the transfer position.

The controller switches the solenoid actuator from the second state to the first state after the trailing edge of the sheet passes through the transfer position. Accordingly, the chute can be moved from the second chute position to the first chute position after the sheet passes through the transfer position and the deflection of the sheet has been relieved.

The drive mechanism may include an electromagnetic clutch.

The electromagnetic clutch is switchable to an engaged state in which the driving force from the motor is transmittable to the rotator and to a disengaged state in which the driving force from the motor is not transmitted to the rotator.

Since the drive mechanism includes the electromagnetic clutch, the rotator can be stopped at the first phase or at the second phase.

The link may be located outward of the sheet conveyed over the chute in a widthwise direction of the sheet perpendicular to the conveyance direction.

The link may be located outward of a sheet conveyance region of the chute in a widthwise direction of the sheet perpendicular to the conveyance direction.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is an illustration showing an image forming apparatus.

FIG. 2 is an illustration showing the vicinity of a chute located at a first chute position.

FIG. 3 is an illustration showing the vicinity of the chute located at a second chute position.

FIG. 4 is a perspective view showing a rotator, a link, a drive mechanism, and the chute.

FIGS. 5A and 5B are perspective views of the rotator.

FIG. 6 is an illustration of the drive mechanism with the chute located at the first chute position as viewed from an inward side in a widthwise direction.

FIG. 7 is an illustration of the drive mechanism with the chute located at the second chute position as viewed from the inward side in the widthwise direction.

FIG. 8 is an illustration of the drive mechanism with the chute located at the first chute position as viewed from an outward side in the widthwise direction.

FIG. 9 is an illustration of the drive mechanism with the chute located at the second chute position as viewed from the outward side in the widthwise direction.

FIG. 10 is an illustration showing a state in which a lever has moved from a first lever position to a second lever position while the rotator is located at the first phase.

FIG. 11 is an illustration showing a state in which a first gear teeth portion of the rotator is meshed with an output gear.

FIG. 12 is an illustration showing a state in which the rotator is rotating toward the second phase.

FIG. 13 is an illustration showing a state in which the lever has moved from the second lever position to the first lever position while the rotator is located at the second phase.

FIG. 14 is an illustration showing a state in which a second gear teeth portion of the rotator is meshed with the output gear.

FIG. 15 is an illustration showing a state in which the rotator is rotating toward the first phase.

FIG. 16 is an illustration showing the rotator and the drive mechanism.

FIG. 17A is an illustration showing a state in which the lever has moved from an engagement position to a disengagement position.

FIG. 17B is an illustration showing a state in which a gear teeth portion of the rotator is meshed with the output gear.

FIG. 18 is an illustration showing the rotator and the drive mechanism.

FIG. 19 is a perspective view showing the rotator, the link, the drive mechanism, and the chute.

FIG. 20A is an illustration of the drive mechanism with the chute located at the first chute position as viewed from the inward side in the widthwise direction.

FIG. 20B is an illustration of the drive mechanism with the chute located at the second chute position as viewed from the inward side in the widthwise direction.

FIG. 21A is an illustration of the drive mechanism with the chute located at the first chute position as viewed from the outward side in the widthwise direction.

FIG. 21B is an illustration of the drive mechanism with the chute located at the second chute position as viewed from the outward side in the widthwise direction.

FIG. 22A is an illustration showing the link and the chute located at the first chute position.

FIG. 22B is an illustration showing the link and the chute located at the second chute position.

FIGS. 23A and 23B are illustrations showing the rotator and the link.

### DESCRIPTION

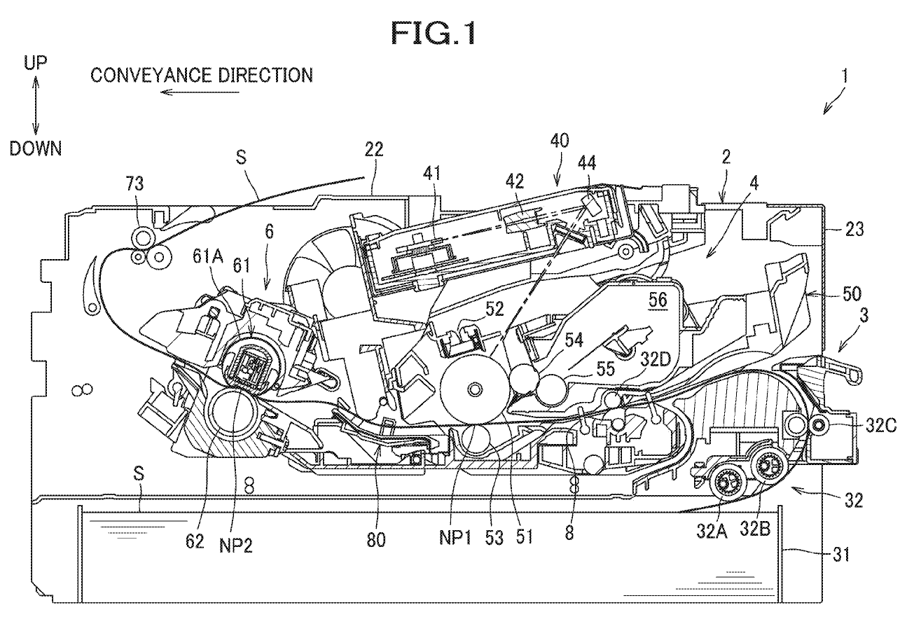

Next, a first embodiment of an image forming apparatus will be described. As shown in FIG. 1, the image forming apparatus 1 is a printer that forms an image on a sheet S. The image forming apparatus 1 comprises a main housing 2, a sheet feeder unit 3, a process unit 4, a fixing device 6, an ejection roller 73, and a sheet sensor 8.

The sheet feeder unit 3 comprises a sheet tray 31 and a sheet feeding device 32. The sheet tray 31 contains sheets S of paper or the like. The sheet feeding device 32 comprises a pickup roller 32A, a separation roller 32B, a conveyance roller 32C, and a registration roller 32D.

The pickup roller 32A feeds the sheets S out of the sheet tray 31. The separation roller 32B separates the sheets S fed by the pickup roller 32A one from the others between the separation roller 32B and a separation pad. The conveyance roller 32C and the registration roller 32D convey each sheet S to the process unit 4.

The process unit 4 transfers a toner image onto the sheet S. The process unit 4 comprises an exposure device 40 and a process cartridge 50.

The exposure device 40 comprises a light source, a polygon mirror 41, a lens 42, a reflecting mirror 44, and other components. As shown by a dash-dotted line, the exposure device 40 emits a beam and exposes a surface of a photosensitive drum 51.

The process cartridge 50 is installable into and removable from the main housing 2 through an opening formed when a front cover 23 is opened. The process cartridge 50 comprises the photosensitive drum 51, a charger 52, a transfer roller 53, a development roller 54, a supply roller 55, and a toner containing unit 56. The photosensitive drum 51 corresponds to an “image carrier”.

The photosensitive drum 51 carries a toner image on its surface. The transfer roller 53 transfers the toner image on the photosensitive drum 51 onto the sheet S at a transfer position NP1 where the transfer roller 53 nips the sheet S in combination with the photosensitive drum 51. The toner containing unit 56 contains toner. The supply roller 55 supplies toner to the development roller 54.

In the process unit 4, the charger 52 charges the surface of the photosensitive drum 51. The exposure device 40 exposes the surface of the photosensitive drum 51. An electrostatic latent image is thereby formed on the photosensitive drum 51. The development roller 54 supplies toner to the photosensitive drum 51. A toner image is thereby formed on the photosensitive drum 51. The photosensitive drum 51 and the transfer roller 53 convey the sheet S fed from the sheet feeder unit 3. The toner image formed on the photosensitive drum 51 is thereby transferred onto the sheet S.

The fixing device 6 is located downstream of the transfer roller 53 in a direction in which the sheet S is conveyed from the transfer position NP1 toward the fixing device 6. The fixing device 6 comprises a heating unit 61 and a pressure roller 62. The pressure roller 62 corresponds to a “pressure rotator”.

The heating unit 61 comprises an endless heating belt 61A, a heater that heats the heating belt 61A, a belt guide that guides the heating belt 61A in a manner that allows the heating belt 61A to rotate, and other components. The heating belt 61A corresponds to a “heating rotator” and heats the sheet S. The pressure roller 62 applies pressure to the sheet S at a fixing position NP2 where the pressure roller 62 nips the sheet S in combination with the heating belt 61A.

In the fixing device 6, the heating unit 61 and the pressure roller 62 convey the sheet S which is conveyed from the process unit 4. The toner image is thereby fixed on the sheet S.

The ejection roller 73 ejects the sheet S conveyed from the fixing device 6 onto an output tray 22.

The sheet sensor 8 is a sensor that detects the sheet S. The sheet sensor 8 comprises, for example, a swing lever that swings upon contact with the sheet S and an optical sensor that detects swinging of the swing lever.

The sheet sensor 8 is located between the registration roller 32D and the transfer position NP1 in the direction in which the sheet S is conveyed from the transfer position NP1 toward the fixing position NP2. In other words, the sheet sensor 8 is located downstream of the registration roller 32D in the direction in which the sheet S is conveyed. The sheet sensor 8 is located upstream of the transfer position NP1 in the direction in which the sheet S is conveyed.

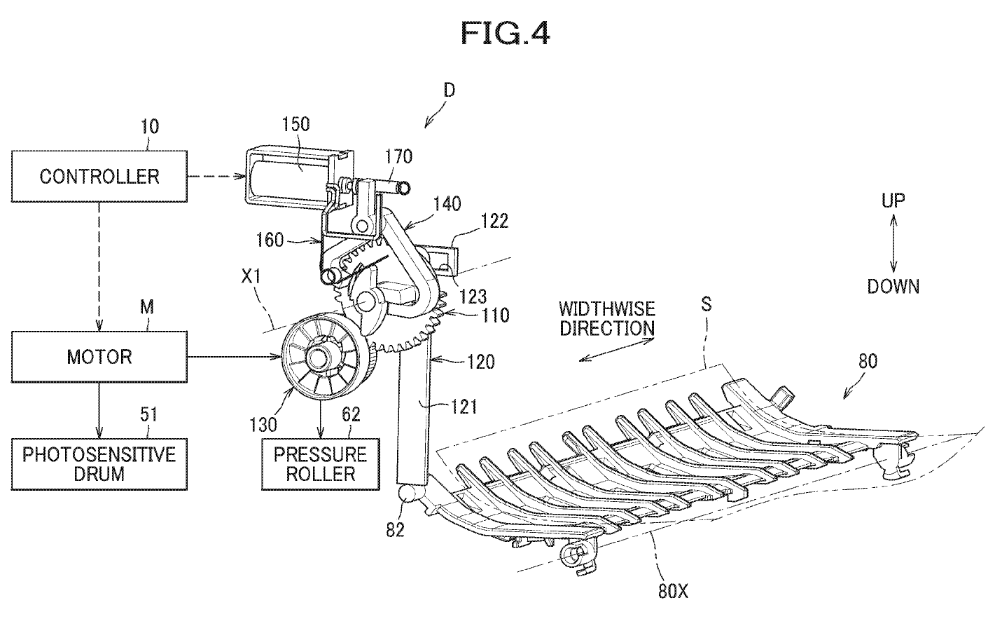

In the following description, the direction in which the sheet S is conveyed from the transfer position NP1 toward the fixing position NP2 is simply referred to as “conveyance direction”. A widthwise direction of the sheet S (see FIG. 4), perpendicular to the conveyance direction, is simply referred to as “widthwise direction”. In this embodiment, the widthwise direction is perpendicular to both of the conveyance direction and an up-down direction.

The up-down direction corresponds to a “first direction transverse to the conveyance direction”. In other words, the first direction is the up-down direction. A lower side corresponds to “one side in the first direction”. An upper side corresponds to “the other side in the first direction”.

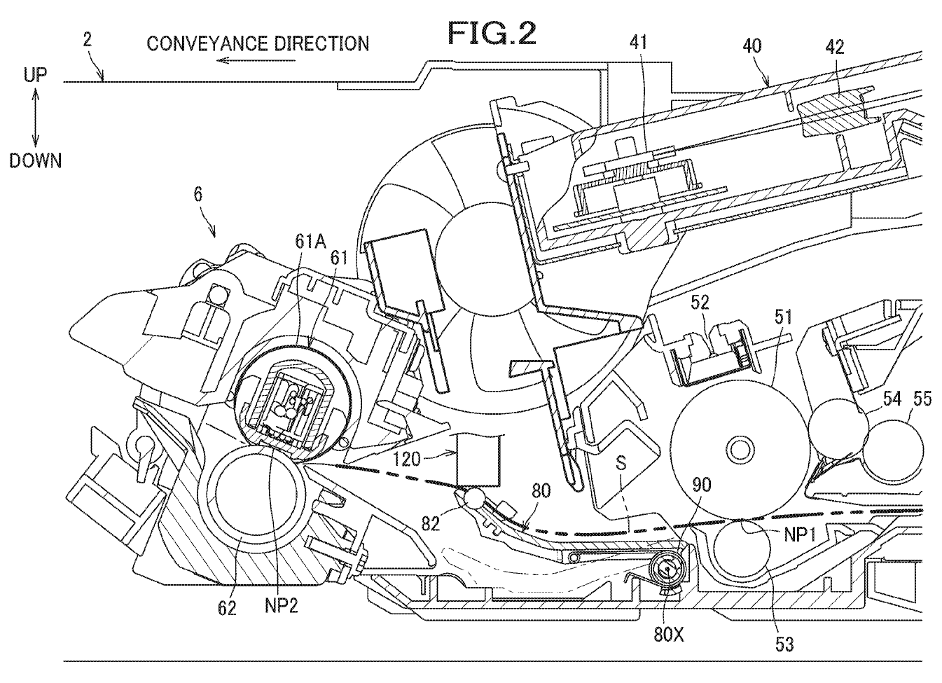

As shown in FIG. 2, the image forming apparatus 1 further comprises a chute 80. The chute 80 is located between the transfer position NP1 and the fixing position NP2 in the conveyance direction and below the sheet S conveyed from the transfer position NP1 toward the fixing position NP2.

The chute 80 is movable between a first chute position shown by a solid line and a second chute position shown by a phantom line in FIG. 2. The chute 80 is movable up and down between the first chute position and the second chute position. The chute 80 has an upstream end and a downstream end in the conveyance direction.

The first chute position, shown by the solid line in FIG. 2, is a position in which the chute 80 guides the sheet S toward the fixing position NP2. When the chute 80 is located at the first chute position, the chute 80 guides a leading edge of the sheet S conveyed toward the fixing device 6 to the fixing position NP2.

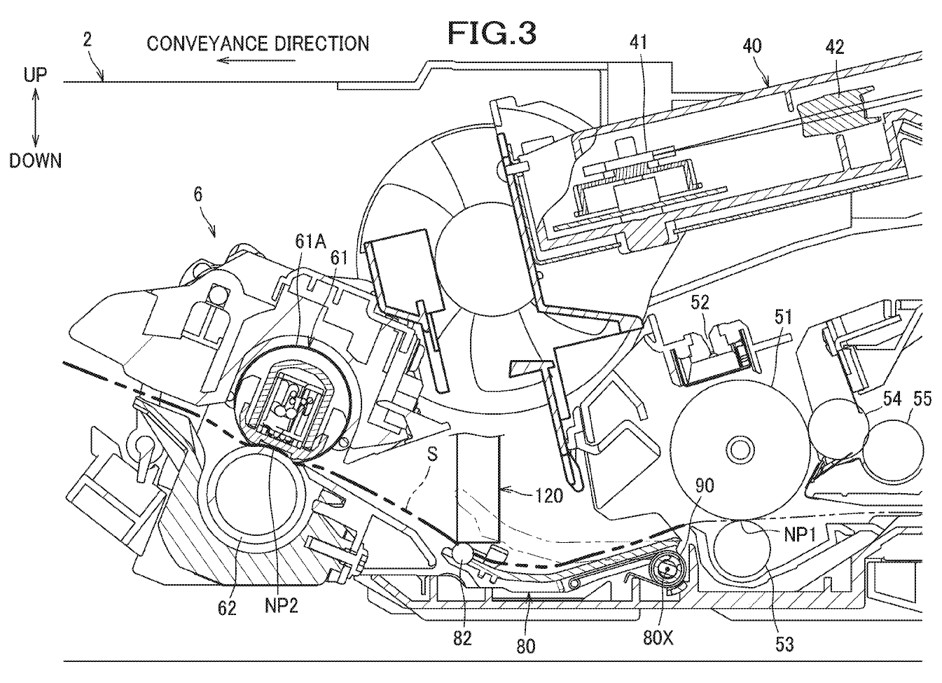

The second chute position shown by a solid line in FIG. 3 is a position lower than the first chute position shown by a phantom line. When the chute 80 is located at the second chute position, downward deflection of the sheet S, which is nipped at the transfer position NP1 and at the fixing position NP2, is allowed.

The chute 80 is swingable between the first chute position and the second chute position. Specifically, the chute 80 is swingable with respect to the main housing 2 about a chute axis 80X extending in the widthwise direction. The chute axis 80X is located at the upstream end of the chute 80. When the chute 80 swings between the first chute position and the second chute position, a portion of the chute 80 located downstream of the chute axis 80X in the conveyance direction moves up and down.

The image forming apparatus 1 further comprises helical torsion springs 90. The helical torsion springs 90 bias the chute 80 toward the first chute position. Specifically, the helical torsion springs 90 bias the chute 80 upward. The helical torsion springs 90 are respectively located at the widthwise ends of the chute 80. The chute 80 biased upward by the helical torsion springs 90 is restricted to the first chute position by the widthwise ends thereof contacting stoppers of the main housing 2.

As shown in FIG. 4, the image forming apparatus 1 further comprises a motor M, a rotator 110, a link 120, a drive mechanism D, and a controller 10.

The motor M is a motor for driving the photosensitive drum 51 and the pressure roller 62. The image forming apparatus 1 moves the chute 80 by the motor M. That is, the image forming apparatus 1 does not comprise a dedicated motor for moving the chute 80.

The rotator 110 receives a driving force from the motor M and rotates. The rotator 110 is rotatable with respect to the main housing 2 about a rotation axis X1 extending in the widthwise direction.

The link 120 is movable in conjunction with rotation of the rotator 110. Specifically, the link 120 is movable up and down in conjunction with rotation of the rotator 110. The link 120 causes the chute 80 to move between the first chute position and the second chute position in conjunction with rotation of the rotator 110. The link 120 is located, in the widthwise direction, outward of the sheet S conveyed over the chute 80.

Outward in the widthwise direction means farther from a central portion of the image forming apparatus 1 in the widthwise direction, and inward in the widthwise direction means closer to the central portion of the image forming apparatus 1 in the widthwise direction.

The drive mechanism D transmits a driving force from the motor M to the rotator 110 and causes the rotator 110 to rotate. The drive mechanism D comprises an output gear 130, a lever 140, a solenoid actuator 150, a helical torsion spring 160, and a helical extension spring 170. The helical torsion spring 160 corresponds to a “first spring”.

The output gear 130 transmits a driving force from the motor M to the rotator 110. The output gear 130 is a gear that transmits the driving force from the motor M to the pressure roller 62. In other words, the image forming apparatus 1 uses the gear for transmitting the driving force from the motor M to the pressure roller 62 as the gear for transmitting the driving force from the motor M to the rotator 110.

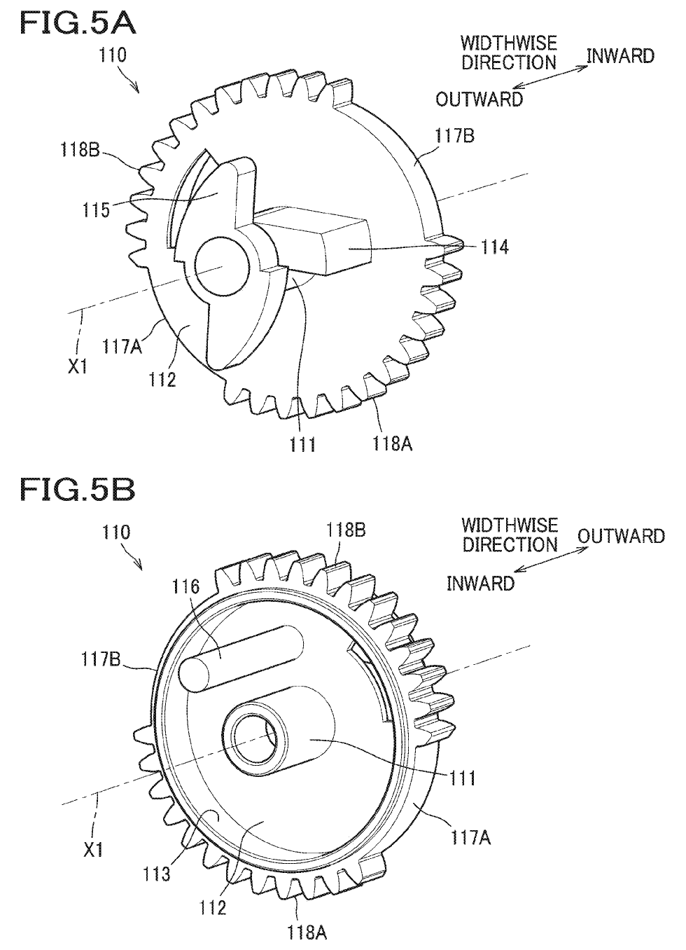

As shown in FIGS. 5A and 5B, the rotator 110 includes a shaft portion 111, a disk portion 112, a hollow cylindrical portion 113, a lever engagement portion 114, a spring engagement portion 115, and a projection 116. The shaft portion 111 is rotatably engaged with the main housing 2 or other components and has a cylindrical shape.

The disk portion 112 extends from the shaft portion 111 in a radial direction of the shaft portion 111 and has a disk shape.

The hollow cylindrical portion 113 protrudes inward, in the widthwise direction, from an outer circumferential portion of the disk portion 112 and has a hollow cylindrical shape.

The disk portion 112 and the hollow cylindrical portion 113 have, on their circumferential surfaces, a first toothless portion 117A, a first gear teeth portion 118A, a second toothless portion 117B, and a second gear teeth portion 118B. The first gear teeth portion 118A and the second gear teeth portion 118B each has gear teeth and is meshable with the output gear 130 (see FIG. 4). The first toothless portion 117A and the second toothless portion 117B have no gear teeth.

The lever engagement portion 114 protrudes in the widthwise direction from a surface of the disk portion 112 facing outward in the widthwise direction. The lever engagement portion 114 is located outward of the shaft portion 111 in the radial direction of the shaft portion 111.

The spring engagement portion 115 extends in the radial direction of the shaft portion 111 from an end of the shaft portion 111 facing outward in the widthwise direction. The spring engagement portion 115 has a shape elongated in the radial direction of the shaft portion 111. The spring engagement portion 115 has a point-symmetric shape with respect to the rotation axis X1 and extends approximately perpendicular to the lever engagement portion 114, as viewed in the widthwise direction.

The projection 116 protrudes in the widthwise direction from a surface of the disk portion 112 facing inward in the widthwise direction. The projection 116 protrudes from a position different from that of the rotation axis X1 and from a position different from that of the shaft portion 111. The projection 116 has a cylindrical shape. A length of the projection 116 in the widthwise direction is longer than a length of the hollow cylindrical portion 113 in the widthwise direction. In other words, the projection 116 extends further inward, in the widthwise direction, than the hollow cylindrical portion 113.

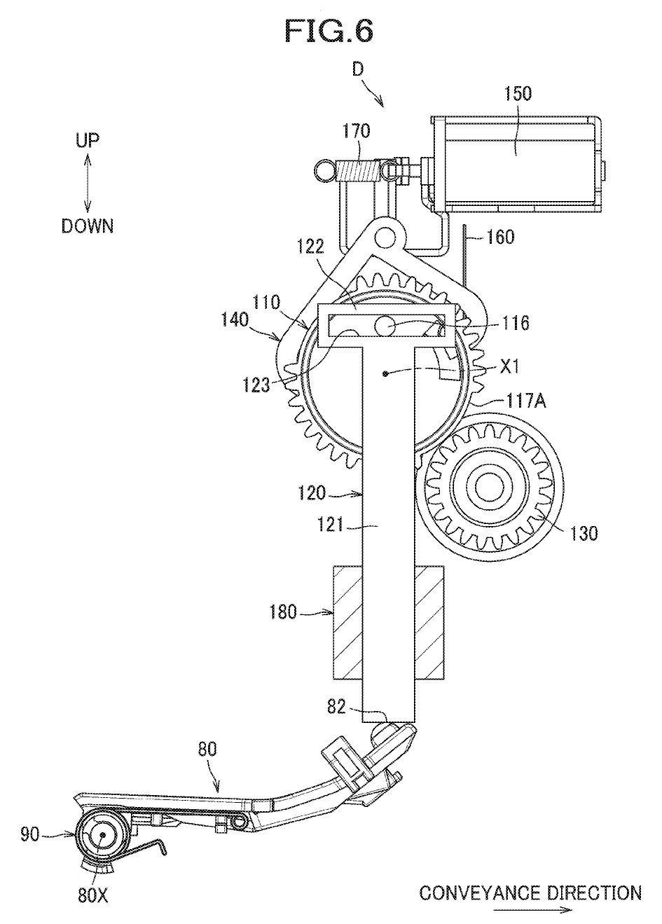

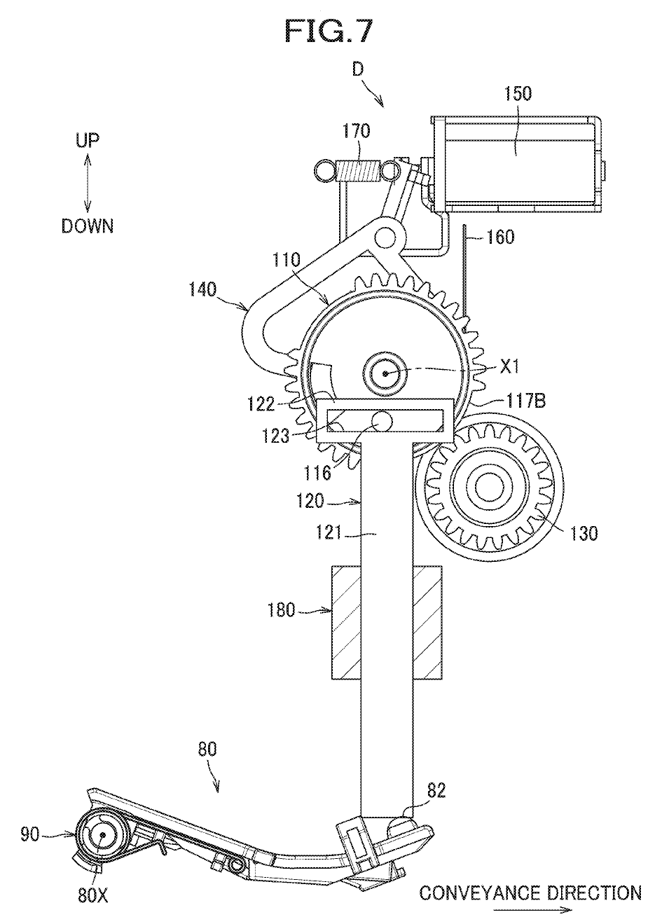

The rotator 110 is rotatable between a first phase shown in FIG. 6 and a second phase shown in FIG. 7. The second phase is a phase rotated 180 degrees from the first phase. The drive mechanism D causes the rotator 110 to rotate between the first phase and the second phase.

As shown in FIG. 6, when the rotator 110 is located at the first phase, the first toothless portion 117A faces the output gear 130. When the rotator 110 is located at the first phase, the projection 116 is located above the rotation axis X1 of the rotator 110.

As shown in FIG. 7, when the rotator 110 is located at the second phase, the second toothless portion 117B faces the output gear 130. When the rotator 110 is located at the second phase, the projection 116 is located below the rotation axis X1 of the rotator 110.

The rotator 110 is aligned with the chute 80 in the up-down direction as viewed in the widthwise direction. Specifically, the rotator 110 is aligned with the downstream end of the chute 80 in the up-down direction. The rotator 110 is located above the chute 80. The rotator 110 is located above the downstream end of the chute 80.

The link 120 is movable, in conjunction with rotation of the rotator 110, between a first position shown in FIG. 6 and a second position shown in FIG. 7. Specifically, the link 120 is movable up and down between the first position and the second position in conjunction with rotation of the rotator 110. The link 120 is slidable up and down between the first position and the second position.

As shown in FIG. 6, the first position is a position in which the chute 80 is located at the first chute position. When the rotator 110 is located at the first phase, the rotator 110 locates the link 120 at the first position. As shown in FIG. 7, the second position is a position in which the chute 80 is located at the second chute position. The second position is below the first position. When the rotator 110 is located at the second phase, the rotator 110 locates the link 120 at the second position.

The link 120 includes a rod 121 and an engagement portion 122.

The rod 121 extends in the up-down direction. A lower end of the rod 121 is in contact with the chute 80. Specifically, the chute 80 has a projection 82 (see also FIG. 4) at the downstream end thereof. The projection 82 protrudes outward in the widthwise direction. The lower end of the rod 121 is in contact with the projection 82 from above.

The engagement portion 122 extends from an upper end portion of the rod 121 in a direction transverse to the rod 121. In the first embodiment, the engagement portion 122 extends in a direction perpendicular to the rod 121 and has an elongated hole 123.

The elongated hole 123 is a hole with which the projection 116 of the rotator 110 is engaged. The elongated hole 123 extends through the engagement portion 122 in the widthwise direction. The elongated hole 123 extends in a direction transverse to a direction in which the link 120 moves. In the first embodiment, the elongated hole 123 extends in a direction perpendicular to the direction in which the link 120 moves.

As the rotator 110 rotates, the projection 116 of the rotator 110 moves within the elongated hole 123, relative to the link 120, in a longitudinal direction of the elongated hole 123.

The image forming apparatus 1 further comprises a guide 180 that guides movement of the link 120. The guide 180 extends in the up-down direction and guides movement of the rod 121 in the up-down direction.

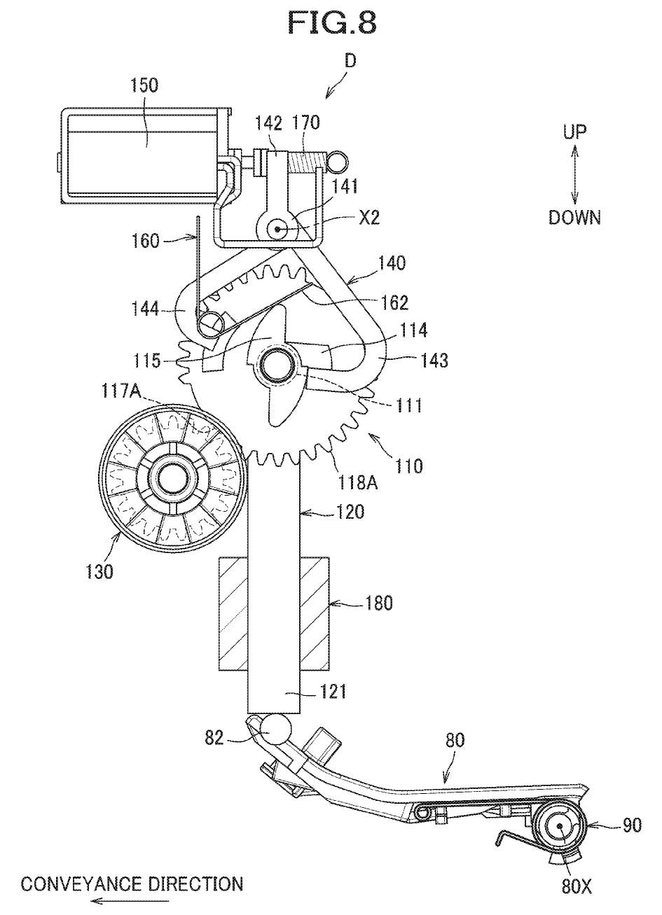

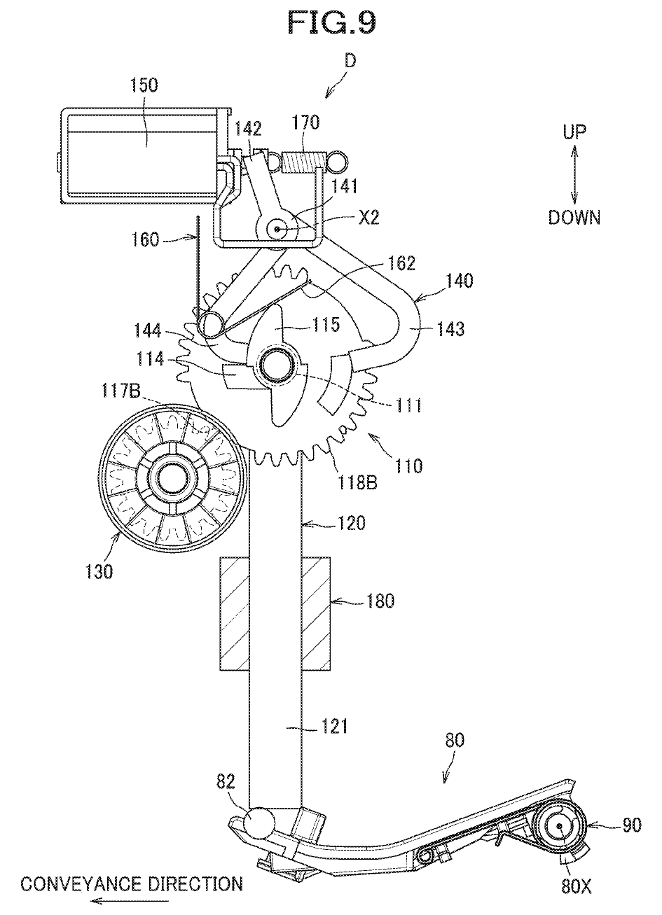

As shown in FIGS. 8 and 9, the lever 140 causes the rotator 110 to stop at the first phase or the second phase when the lever 140 is engaged with the lever engagement portion 114 of the rotator 110. The lever 140 permits rotation of the rotator 110 when the lever 140 is disengaged from the lever engagement portion 114 of the rotator 110.

As shown in FIG. 8, the lever 140 includes a shaft portion 141, an engagement portion 142, a first arm 143, and a second arm 144.

The shaft portion 141 is rotatably engaged with the main housing 2 or other components. The shaft portion 141 is rotatable with respect to the main housing 2 about a lever axis X2 extending in the widthwise direction. The shaft portion 141 has a cylindrical shape.

The engagement portion 142 extends upward from the shaft portion 141.

The first arm 143 causes the rotator 110 to stop at the first phase upon engagement with the lever engagement portion 114. The first arm 143 extends obliquely downward from the shaft portion 141 and has an end portion bent and extending toward the shaft portion 111 of the rotator 110. The end portion of the first arm 143 is engageable with the lever engagement portion 114.

As shown in FIG. 9, the second arm 144 causes the rotator 110 to stop at the second phase upon engagement with the lever engagement portion 114. The second arm 144 extends obliquely downward from the shaft portion 141 in a direction opposite to the first arm 143 and has an end portion bent and extending toward the shaft portion 111 of the rotator 110. The end portion of the second arm 144 is engageable with the lever engagement portion 114.

The lever 140 is movable between a first lever position shown in FIG. 8 and a second lever position shown in FIG. 9. In the first embodiment, the lever 140 is swingable between the first lever position and the second lever position. Specifically, the lever 140 is swingable with respect to the main housing 2 about the lever axis X2.

The first lever position shown in FIG. 8 is a position where the first arm 143 is engageable with the lever engagement portion 114 and the second arm 144 is not engageable with the lever engagement portion 114. The second lever position shown in FIG. 9 is a position where the first arm 143 is not engageable with the lever engagement portion 114 and the second arm 144 is engageable with the lever engagement portion 114.

The solenoid actuator 150 causes the lever 140 to move. A movable pin of the solenoid actuator 150 is connected to the engagement portion 142 of the lever 140. The solenoid actuator 150 is switchable between a first state shown in FIG. 8 and a second state shown in FIG. 9. The first state shown in FIG. 8 is a state that locates the lever 140 at the first lever position. The second state shown in FIG. 9 is a state that locates the lever 140 at the second lever position.

When the solenoid actuator 150 is switched from the first state shown in FIG. 8 to the second state shown in FIG. 9, the pin of the solenoid actuator 150 pulls the engagement portion 142 of the lever 140. The lever 140 thereby swings about the lever axis X2 in the counterclockwise direction of FIG. 9, which causes the lever 140 to move from the first lever position to the second lever position.

When the solenoid actuator 150 is switched from the second state shown in FIG. 9 to the first state shown in FIG. 8, the pulling force exerted on the engagement portion 142 by the pin of the solenoid actuator 150 is released. As a result, the helical extension spring 170 pulls the engagement portion 142 of the lever 140. The lever 140 thereby swings in the clockwise direction of FIG. 8 about the lever axis X2, which causes the lever 140 to move from the second lever position to the first lever position.

As one example, the solenoid actuator 150 is in the first state when it is not energized. The solenoid actuator 150 is in the second state when it is energized. Hereinafter, the first state is referred to as “OFF state” and the second state is referred to as “ON state”.

The helical extension spring 170 biases the lever 140 toward the first lever position. One end of the helical extension spring 170 is engaged with the engagement portion 142. The other end of the helical extension spring 170 is engaged with the main housing 2 or other components.

The helical torsion spring 160 applies a rotational force to the rotator 110 located at the first phase or the second phase. The helical torsion spring 160 has an arm 162. The arm 162 contacts the spring engagement portion 115 of the rotator 110. The helical torsion spring 160 biases the rotator 110 by the arm 162 in the clockwise direction of FIG. 8.

The controller 10 (see FIG. 4) comprises a central processing unit (CPU), a random-access memory (RAM), a read-only memory (ROM), input/output circuits, and other components. The controller 10 exercises control by executing various arithmetic processing based on programs and data stored in the ROM or the like. The controller 10 controls an energization state of the solenoid actuator 150.

Next, operation of the drive mechanism D, the rotator 110, and the link 120 will be described. As shown in FIG. 8, when the rotator 110 is located at the first phase, the first toothless portion 117A faces the output gear 130.

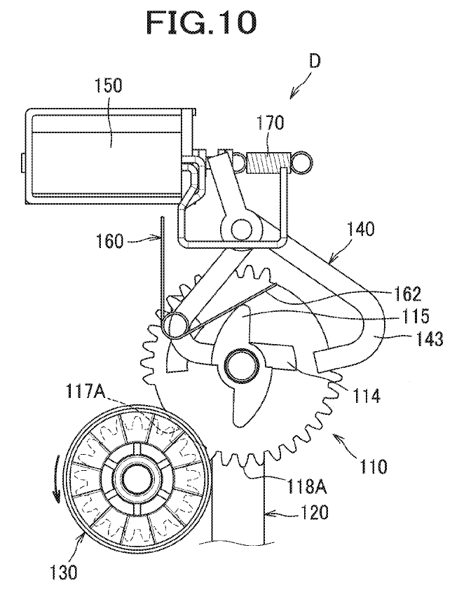

The controller 10 switches the solenoid actuator 150 from the OFF state to the ON state as shown in FIG. 10 when the rotator 110 is located at the first phase. In the first embodiment, the controller 10 switches the solenoid actuator 150 from the OFF state to the ON state after the leading edge of the sheet S passes through the fixing position NP2.

Specifically, the controller 10 switches the solenoid actuator 150 from the OFF state to the ON state if a first time period has elapsed after the sheet sensor 8 detects the sheet S. The first time period is set, for example, such that the sheet S (see the thin phantom line in FIG. 2) is located at a position immediately after the leading edge of the sheet S has passed through the fixing position NP2 when the first time period has elapsed after the sheet sensor 8 detects the sheet S.

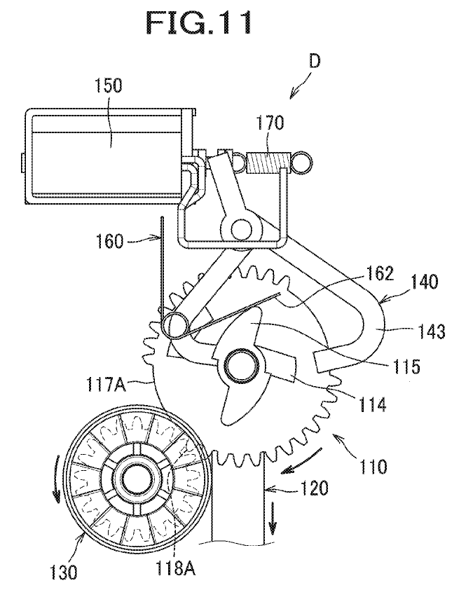

When the solenoid actuator 150 is switched to the ON state, the lever 140 swings from the first lever position to the second lever position shown in FIG. 10. As a result, the first arm 143 of the lever 140 is disengaged from the lever engagement portion 114 of the rotator 110. Thus, as shown in FIG. 11, the rotator 110 rotates in the clockwise direction of FIG. 11 by a biasing force of the helical torsion spring 160.

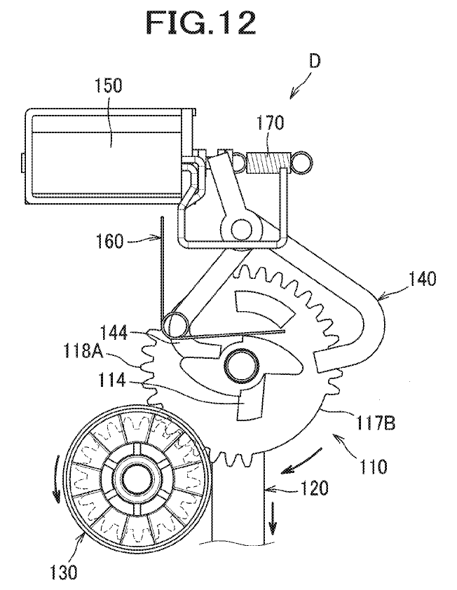

Thereafter, the first gear teeth portion 118A of the rotator 110 meshes with the output gear 130. Then, as shown in FIG. 12, a driving force is transmitted from the output gear 130 to the rotator 110 and causes the rotator 110 to rotate toward the second phase. As shown in FIG. 9, the lever engagement portion 114 engages the second arm 144 when the rotator 110 reaches the second phase. As a result, the rotator 110 stops at the second phase.

In conjunction with rotation of the rotator 110 from the first phase to the second phase, the link 120 slides downward from the first position toward the second position. As a result, the lower end of the rod 121 pushes down the projection 82 of the chute 80. As shown in FIG. 3, the chute 80 thereby moves from the first chute position shown by the phantom line to the second chute position shown by the solid line. Thus, the chute 80 allows downward deflection of the sheet S, which is nipped at the transfer position NP1 and at the fixing position NP2.

As shown in FIG. 9, when the rotator 110 is located at the second phase, the second toothless portion 117B faces the output gear 130.

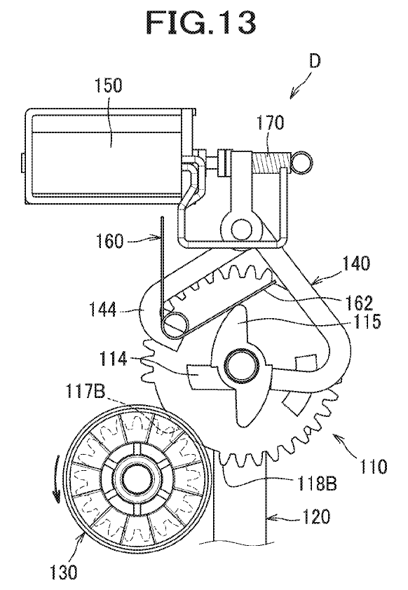

The controller 10 switches the solenoid actuator 150 from the ON state to the OFF state as shown in FIG. 13 when the rotator 110 is located at the second phase. In the first embodiment, the controller 10 switches the solenoid actuator 150 from the ON state to the OFF state after a trailing edge of the sheet S passes through the transfer position NP1.

Specifically, the controller 10 switches the solenoid actuator 150 from the ON state to the OFF state if a second time period has elapsed after the sheet sensor 8 no longer detects the sheet S. Considering the presence of a following sheet S, the second time period is set such that the chute 80 moves to the first chute position at a timing that allows a leading edge of the following sheet S to be guided to the fixing position NP2. The second time period is set, for example, such that the sheet S (see the thick phantom line in FIG. 3) is located at a position immediately after the trailing edge of the sheet S has passed through the transfer position NP1 when the second time period has elapsed after the sheet sensor 8 no longer detects the sheet S.

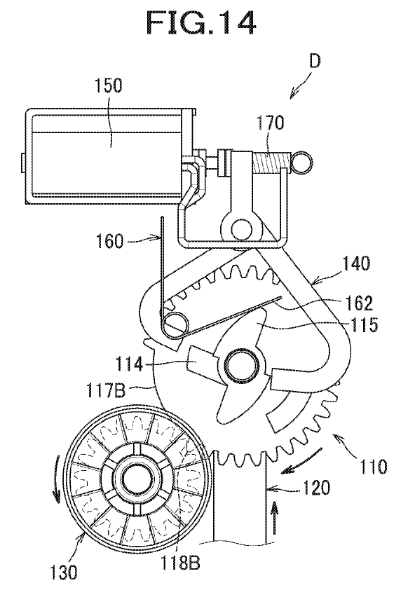

When the solenoid actuator 150 is switched to the OFF state, the lever 140 swings from the second lever position to the first lever position shown in FIG. 13 by a biasing force of the helical extension spring 170. The second arm 144 of the lever 140 is thereby disengaged from the lever engagement portion 114 of the rotator 110. Thus, as shown in FIG. 14, the rotator 110 rotates in the clockwise direction of FIG. 14 by the biasing force of the helical torsion spring 160.

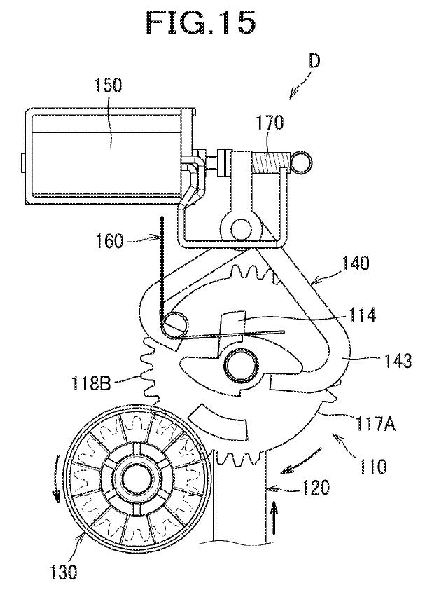

Thereafter, the second gear teeth portion 118B of the rotator 110 meshes with the output gear 130. Then, as shown in FIG. 15, a driving force is transmitted from the output gear 130 to the rotator 110 and causes the rotator 110 to rotate toward the first phase. As shown in FIG. 8, the lever engagement portion 114 engages the first arm 143 when the rotator 110 reaches the first phase. As a result, the rotator 110 stops at the first phase.

In conjunction with rotation of the rotator 110 from the second phase toward the first phase, the link 120 slides upward from the second position toward the first position. As shown in FIG. 2, the chute 80 thereby moves from the second chute position shown by the phantom line to the first chute position shown by the solid line by a biasing force of the helical torsion springs 90. Thus, the chute 80 guides the leading edge of the following sheet S (see the thick phantom line in FIG. 2) toward the fixing position NP2.

Next, advantageous effects of the first embodiment will be described.

Since the image forming apparatus 1 comprises the rotator 110 and the link 120, the image forming apparatus 1 can move the chute 80 by the motor M. Accordingly, the chute 80 can be moved without using a large solenoid actuator.

Compared to an alternative configuration in which the chute is moved by power from a solenoid actuator, impacts caused by the chute 80 moving from one of the first chute position and the second chute position to the other of the first chute position and the second chute position can be reduced. Thus, for example, distortion of unfixed toner images on the sheet S can be minimized.

The image forming apparatus 1 comprises the drive mechanism D that causes the rotator 110 to rotate between the first phase and the second phase. Thus, the position of the link 120 can be changed in two stages according to the phase of the rotator 110.

Since the first toothless portion 117A faces the output gear 130 when the rotator 110 is located at the first phase, the rotator 110 can be stopped at the first phase. Since the second toothless portion 117B faces the output gear 130 when the rotator 110 is located at the second phase, the rotator 110 can be stopped at the second phase.

The solenoid actuator 150 is a solenoid actuator for moving the lever 140. Thus, a compact solenoid actuator can be used as compared to an alternative solenoid actuator for moving a chute.

The solenoid actuator 150 is switchable between the OFF state that locates the lever 140 at the first lever position and the ON state that locates the lever 140 at the second lever position. Accordingly, the position of the lever 140 can be switched quickly by simply switching the solenoid actuator 150 from one of the OFF state and the ON state to the other of the OFF state and the ON state, without returning to the original state.

The motor M is a motor for driving the photosensitive drum 51 and the pressure roller 62. Accordingly, the chute 80 can be moved using the motor M for driving the photosensitive drum 51 and the pressure roller 62. Thus, a dedicated motor for moving the chute 80 can be dispensed with.

The output gear 130 is a gear that transmits the driving force from the motor M to the pressure roller 62. Accordingly, the rotator 110 can be driven using the gear that transmits the driving force from the motor M to the pressure roller 62. Thus, the number of parts of the drive mechanism D can be reduced and the drive mechanism D can be downsized.

The controller 10 switches the solenoid actuator 150 from the OFF state to the ON state after the leading edge of the sheet S passes through the fixing position NP2. Accordingly, the chute 80 is located at the first chute position before the leading edge of the sheet S enters the fixing position NP2. The posture of the sheet S entering the fixing position NP2 can thereby be kept at a proper posture by the chute 80.

After the leading edge of the sheet S passes through the fixing position NP2, the chute 80 moves to the second chute position. Accordingly, a space for the sheet S to deflect toward the chute 80 can be secured. Thus, distortion of unfixed toner images on the sheet S can be minimized.

The controller 10 switches the solenoid actuator 150 from the ON state to the OFF state after the trailing edge of the sheet S passes through the transfer position NP1. Accordingly, the chute 80 can be moved from the second chute position to the first chute position after the sheet S passes through the transfer position NP1 and the deflection of the sheet S has been relieved.

The image forming apparatus 1 comprises the guide 180 that guides movement of the slidable link 120. Thus, movement of the link 120 can be stabilized.

Next, a second embodiment will be described. In the following description, the same components as those of the first embodiment are denoted by the same reference characters, and explanations thereof will be omitted as appropriate. Points different from the first embodiment will be described in detail.

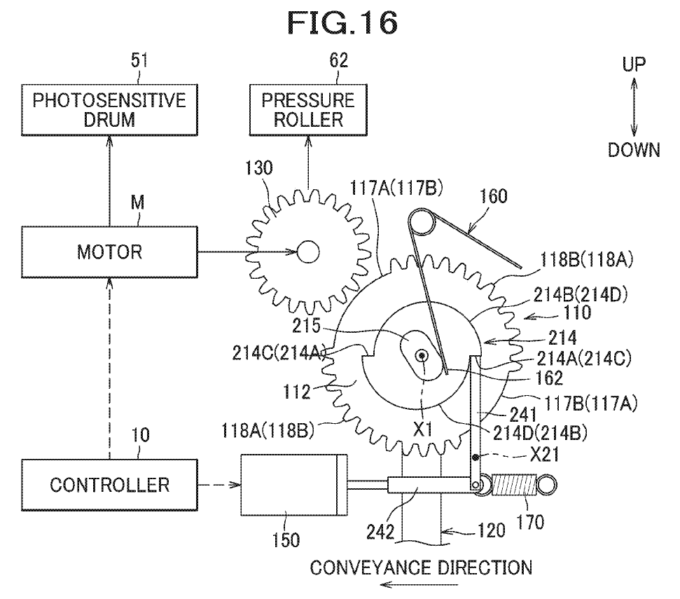

As shown in FIG. 16, the second embodiment is another configuration of a mechanism that causes the rotator 110 to rotate by 180-degree increments. The image forming apparatus 1 comprises a rotator 110, a link 120, an output gear 130, a first lever 241, a second lever 242, a solenoid actuator 150, a helical torsion spring 160, and a helical extension spring 170.

The rotator 110 includes a cam 214 and a spring engagement portion 215. Specifically, the rotator 110 includes the cam 214 and the spring engagement portion 215 instead of the lever engagement portion 114 and the spring engagement portion 115 described in the first embodiment.

The cam 214 protrudes in the widthwise direction from a surface of the disk portion 112 facing outward in the widthwise direction. The cam 214 has, on its circumferential surface, a first engagement surface 214A, a first connection surface 214B, a second engagement surface 214C, and a second connection surface 214D.

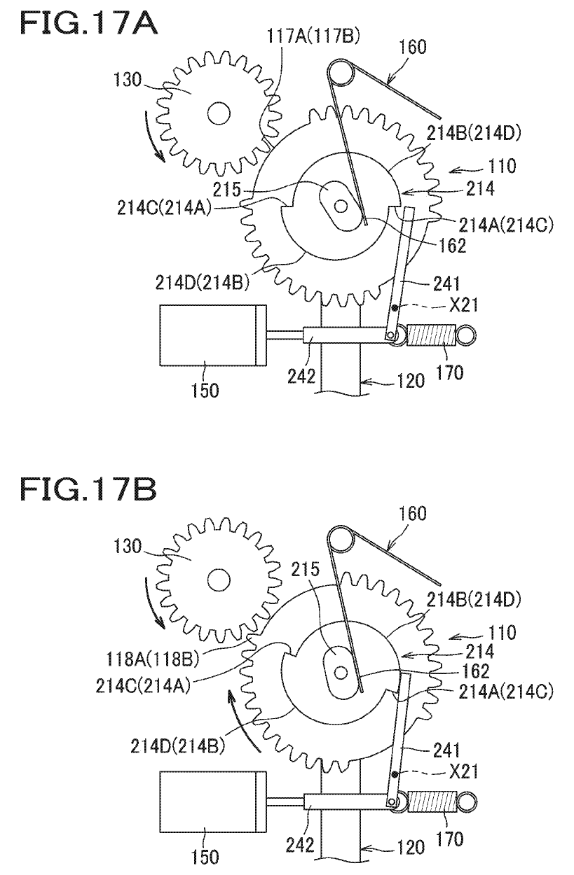

In FIGS. 16, 17A and 17B, reference characters for the first engagement surface 214A, the first connection surface 214B, the second engagement surface 214C, the second connection surface 214D, a first toothless portion 117A, a second toothless portion 117B, a first gear teeth portion 118A, and a second gear teeth portion 118B shown without parentheses correspond to the rotator 110 located at the first phase, and shown in parentheses correspond to the rotator 110 located at the second phase.

The first engagement surface 214A is a surface engageable by the first lever 241. The first engagement surface 214A extends in a radial direction of the disk portion 112. The first engagement surface 214A causes the rotator 110 to stop at the first phase when the first lever 241 engages the first engagement surface 214A.

The second engagement surface 214C is a surface engageable by the first lever 241. The second engagement surface 214C extends in the radial direction of the disk portion 112. The second engagement surface 214C causes the rotator 110 to stop at the second phase when the first lever 241 engages the second engagement surface 214C.

The first connection surface 214B is a surface that connects the first engagement surface 214A and the second engagement surface 214C. The first connection surface 214B is configured such that its distance from the rotation axis X1 gradually decreases from the first engagement surface 214A toward the second engagement surface 214C.

The second connection surface 214D is a surface that connects the second engagement surface 214C and the first engagement surface 214A. The second connection surface 214D is configured such that its distance from the rotation axis X1 gradually decreases from the second engagement surface 214C toward the first engagement surface 214A.

The spring engagement portion 215 protrudes in the widthwise direction from a surface of the cam 214 facing outward in the widthwise direction. The spring engagement portion 215 has an oval shape as viewed in the widthwise direction. The cam 214 and the spring engagement portion 215 have point-symmetric shapes with respect to the rotation axis X1 as viewed in the widthwise direction.

An arm 162 of the helical torsion spring 160 contacts the spring engagement portion 215. The helical torsion spring 160 biases the rotator 110 by the arm 162 in the clockwise direction of FIG. 16.

The first lever 241 extends in the up-down direction and is movable between an engagement position shown in FIG. 16 and a disengagement position shown in FIG. 17A. In the second embodiment, the first lever 241 is rotatable between the engagement position and the disengagement position. Specifically, the first lever 241 is rotatable with respect to the main housing 2 about a lever axis X21 extending in the widthwise direction. The lever axis X21 is located between an upper end and a lower end of the first lever 241 as viewed in the widthwise direction.

The engagement position shown in FIG. 16 is a position at which the first lever 241 is engageable with the first engagement surface 214A or the second engagement surface 214C of the rotator 110. The disengagement position shown in FIG. 17A is a position in which the first lever 241 is not engageable with the first engagement surface 214A or the second engagement surface 214C of the rotator 110.

The second lever 242 extends in the conveyance direction. The second lever 242 is slidable in the conveyance direction. One end of the second lever 242 is connected to a pin of the solenoid actuator 150. The other end of the second lever 242 is connected to a lower end of the first lever 241 in a manner that allows the first lever 241 to rotate.

The solenoid actuator 150 causes the first lever 241 to move. The solenoid actuator 150 is switchable between an OFF state shown in FIG. 16 and an ON state shown in FIG. 17A. The OFF state shown in FIG. 16 is a state in which the first lever 241 is located at the engagement position. The ON state shown in FIG. 17A is a state in which the first lever 241 is located at the disengagement position.

When the solenoid actuator 150 is switched from the OFF state shown in FIG. 16 to the ON state shown in FIG. 17A, the pin of the solenoid actuator 150 pulls the second lever 242. As a result, the first lever 241 rotates about the lever axis X21 in the clockwise direction of FIG. 17A and moves from the engagement position to the disengagement position.

When the solenoid actuator 150 is switched from the ON state shown in FIG. 17A to the OFF state shown in FIG. 16, the pulling force exerted on the second lever 242 by the pin of the solenoid actuator 150 is released. As a result, the helical extension spring 170 pulls the second lever 242. The first lever 241 thereby rotates about the lever axis X21 in the counterclockwise direction of FIG. 16 and moves from the disengagement position to the engagement position.

The helical extension spring 170 biases the first lever 241 toward the engagement position. One end of the helical extension spring 170 engages the other end of the second lever 242. The other end of the helical extension spring 170 engages the main housing 2 or other components.

Next, movement of the rotator 110 of the second embodiment rotating from the first phase to the second phase will be described.

As shown in FIGS. 16 and 17A, the controller 10 switches the solenoid actuator 150 from the OFF state to the ON state when the rotator 110 is located at the first phase.

In the second embodiment, the controller 10 switches the solenoid actuator 150 from the OFF state to the ON state after the leading edge of the sheet S passes through the fixing position NP2. Specifically, if a first time period has elapsed after the sheet sensor 8 detects the sheet S, the controller 10 switches the solenoid actuator 150 from the OFF state to the ON state.

As a result, the first lever 241 rotates from the engagement position to the disengagement position. The first lever 241 is thereby disengaged from the first engagement surface 214A of the rotator 110. Thus, the rotator 110 rotates in the clockwise direction of FIG. 17A by a biasing force of the helical torsion spring 160.

As shown in FIG. 17B, when the rotator 110 rotates, the first gear teeth portion 118A meshes with the output gear 130. As a result, a driving force is transmitted from the output gear 130 to the rotator 110 and causes the rotator 110 to rotate toward the second phase.

In the second embodiment, the controller 10 switches the solenoid actuator 150 from the ON state to the OFF state before the rotator 110 reaches the second phase. Specifically, if a third time period has elapsed after the solenoid actuator 150 is switched from the OFF state to the ON state, the controller 10 switches the solenoid actuator 150 from the ON state to the OFF state. The third time period is shorter than the first time period. The third time period is set, for example, to a time period that elapses immediately after the rotator 110 starts rotating.

When the solenoid actuator 150 is switched from the OFF state to the ON state, the first lever 241 is biased by the helical extension spring 170 from the disengagement position toward the engagement position. Thus, the first lever 241 comes into contact with the cam 214 of the rotator 110.

In conjunction with rotation of the rotator 110 from the first phase to the second phase, the link 120 slides downward from the first position toward the second position. As a result, the chute 80 moves from the first chute position to the second chute position.

When the rotator 110 reaches the second phase, the first lever 241 moves from the disengagement position to the engagement position by the helical extension spring 170. The first lever 241 is thereby engaged with the second engagement surface 214C. As a result, the rotator 110 stops at the second phase.

Next, movement of the rotator 110 of the second embodiment rotating from the second phase to the first phase will be described with reference to the reference characters in parentheses in FIGS. 16, 17A and 17B.

As shown in FIGS. 16 and 17A, the controller 10 switches the solenoid actuator 150 from the OFF state to the ON state when the rotator 110 is located at the second phase.

In the second embodiment, the controller 10 switches the solenoid actuator 150 from the OFF state to the ON state after the trailing edge of the sheet S passes through the transfer position NP1. Specifically, if a second time period has elapsed after the sheet sensor 8 no longer detects the sheet S, the controller 10 switches the solenoid actuator 150 from the OFF state to the ON state.

As a result, the first lever 241 rotates from the engagement position to the disengagement position. The first lever 241 is thereby disengaged from the second engagement surface 214C of the rotator 110. Thus, the rotator 110 rotates in the clockwise direction of FIG. 17A by a biasing force of the helical torsion spring 160.

As shown in FIG. 17B, when the rotator 110 rotates, the second gear teeth portion 118B meshes with the output gear 130. As a result, a driving force is transmitted from the output gear 130 to the rotator 110 and causes the rotator 110 to rotate toward the first phase.

In the second embodiment, the controller 10 switches the solenoid actuator 150 from the ON state to the OFF state before the rotator 110 reaches the first phase. Specifically, if the third time period has elapsed after the solenoid actuator 150 is switched from the OFF state to the ON state, the controller 10 switches the solenoid actuator 150 from the ON state to the OFF state.

When the solenoid actuator 150 is switched from the OFF state to the ON state, the first lever 241 is biased by the helical extension spring 170 from the disengagement position toward the engagement position. Thus, the first lever 241 comes into contact with the cam 214 of the rotator 110.

In conjunction with rotation of the rotator 110 from the second phase to the first phase, the link 120 slides upward from the second position toward the first position. As a result, the chute 80 moves from the second chute position to the first chute position.

When the rotator 110 reaches the first phase, the first lever 241 moves from the disengagement position to the engagement position by the helical extension spring 170. The first lever 241 is thereby engaged with the first engagement surface 214A. As a result, the rotator 110 stops at the first phase.

Next, advantageous effects of the second embodiment will be described.

The controller 10 switches the solenoid actuator 150 from the OFF state to the ON state after the leading edge of the sheet S passes through the fixing position NP2. Accordingly, the chute 80 is located at the first chute position before the leading edge of the sheet S enters the fixing position NP2. The posture of the sheet S entering the fixing position NP2 can thereby be kept at a proper posture by the chute 80.

The controller 10 switches the solenoid actuator 150 from the OFF state to the ON state before the rotator 110 reaches the second phase. Accordingly, the chute 80 moves to the second chute position after the leading edge of the sheet S passes through the fixing position NP2. As a result, a space for the sheet S to deflect toward the chute 80 can be secured. Thus, distortion of unfixed toner images on the sheet S can be minimized.

The controller 10 switches the solenoid actuator 150 from the OFF state to the ON state after the trailing edge of the sheet S passes through the transfer position NP1. Accordingly, the chute 80 can be moved from the second chute position to the first chute position after the sheet S passes through the transfer position NP1 and deflection of the sheet S is relieved.

The controller 10 switches the solenoid actuator 150 from the ON state to the OFF state before the rotator 110 reaches the first phase. Accordingly, the chute 80 can be stopped at the first chute position.

Next, a third embodiment will be described.

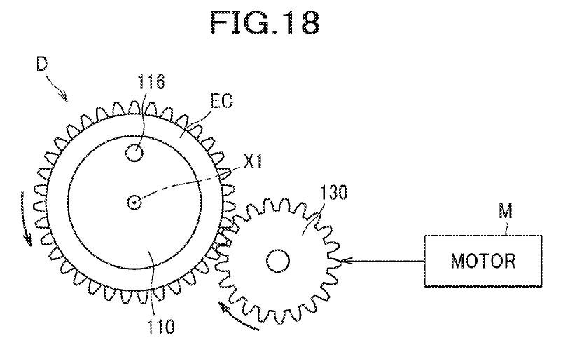

As shown in FIG. 18, the third embodiment is another configuration of a mechanism that causes the rotator 110 to rotate. The drive mechanism D comprises an electromagnetic clutch EC. Specifically, the drive mechanism D comprises the electromagnetic clutch EC instead of the lever 140, the solenoid actuator 150, the helical torsion spring 160, and the helical extension spring 170 described in the first embodiment.

The electromagnetic clutch EC is switchable to an engaged state and to a disengaged state. The engaged state is a state in which a driving force from the motor M is transmittable to the rotator 110. The disengaged state is a state in which a driving force from the motor M is not transmitted to the rotator 110. As one example, the electromagnetic clutch EC is in the engaged state when energized and is in the disengaged state when not energized. The energization state of the electromagnetic clutch EC can be controlled by the controller 10. For example, the controller 10 may control the energization state of the electromagnetic clutch EC based on a signal from a sensor that detects a position of the link 120 or the chute 80.

Since the drive mechanism D comprises the electromagnetic clutch EC, the rotator 110 can be stopped at the first phase or at the second phase. Since it is not necessary to provide the lever 140, the solenoid actuator 150, the helical torsion spring 160, and other components described in the first embodiment, the mechanical configuration of the drive mechanism D can be simplified.

In the third embodiment, the rotator 110 may not comprise the lever engagement portion 114, the spring engagement portion 115, and the gear teeth portions 118A, 118B described in the first embodiment.

Next, a fourth embodiment will be described.

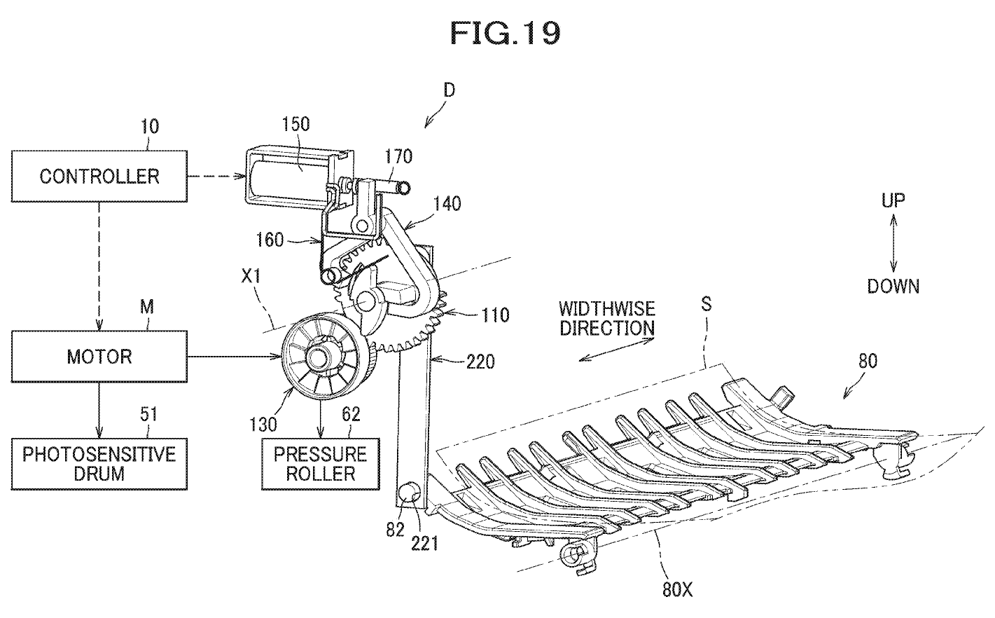

As shown in FIG. 19, the fourth embodiment is another configuration of a link that causes the chute 80 to move. The image forming apparatus 1 comprises a link 220 instead of the link 120 described in the first embodiment. The image forming apparatus 1 of the fourth embodiment does not comprise the helical torsion springs 90, described in the first embodiment, that bias the chute 80 toward the first chute position.

The link 220 extends in the up-down direction. The link 220 has a plate shape. The link 220 is directly connected to the chute 80. Specifically, a lower end of the link 220 is directly connected to the downstream end of the chute 80.

In more detail, the link 220 has a hole 221 in the lower end thereof. The hole 221 is a hole that receives the projection 82 of the chute 80. The hole 221 extends through the link 220 in the widthwise direction. The link 220 is connected to the chute 80 such that the link 220 is rotatable about the projection 82 with the projection 82 engaged with the hole 221. The link 220 is directly connected to the chute 80 to push the chute 80 either upward or downward.

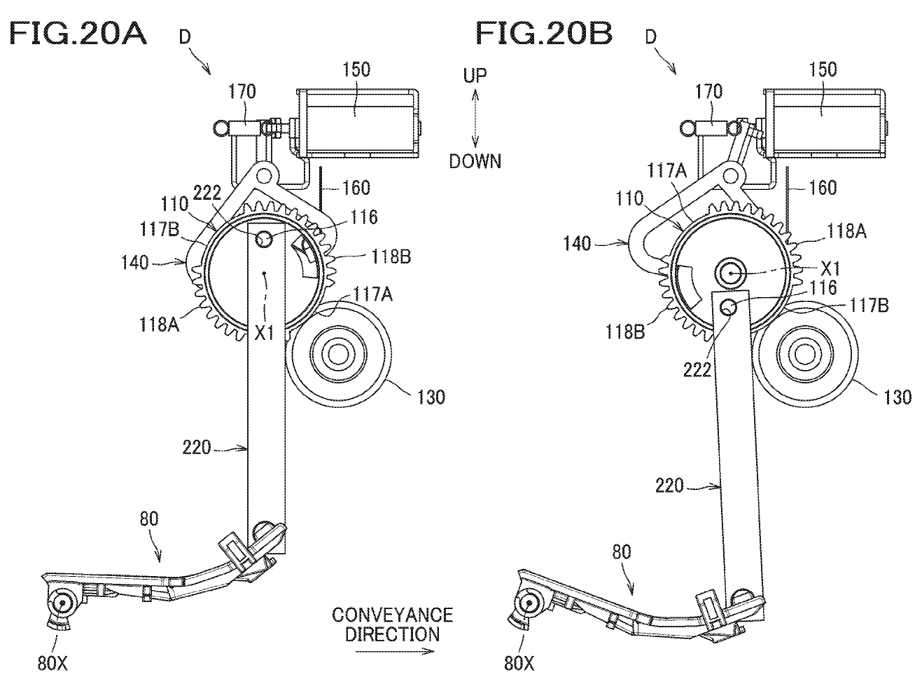

As shown in FIGS. 20A and 20B, the link 220 is directly connected to the rotator 110. Specifically, an upper end of the link 220 is directly connected to the rotator 110. In more detail, the link 220 has a hole 222 in the upper end thereof. The hole 222 is a hole that receives the projection 116 of the rotator 110. The hole 222 extends through the link 220 in the widthwise direction. The link 220 is connected to the rotator 110 such that the link 220 is rotatable about the projection 116 with the projection 116 engaged with the hole 222.

The projection 116 corresponds to a “connection portion” of the link 220 and the rotator 110. When the rotator 110 is located at the first phase, the projection 116 is located above the rotation axis X1 of the rotator 110. When the rotator 110 is located at the second phase, the projection 116 is located below the rotation axis X1 of the rotator 110.

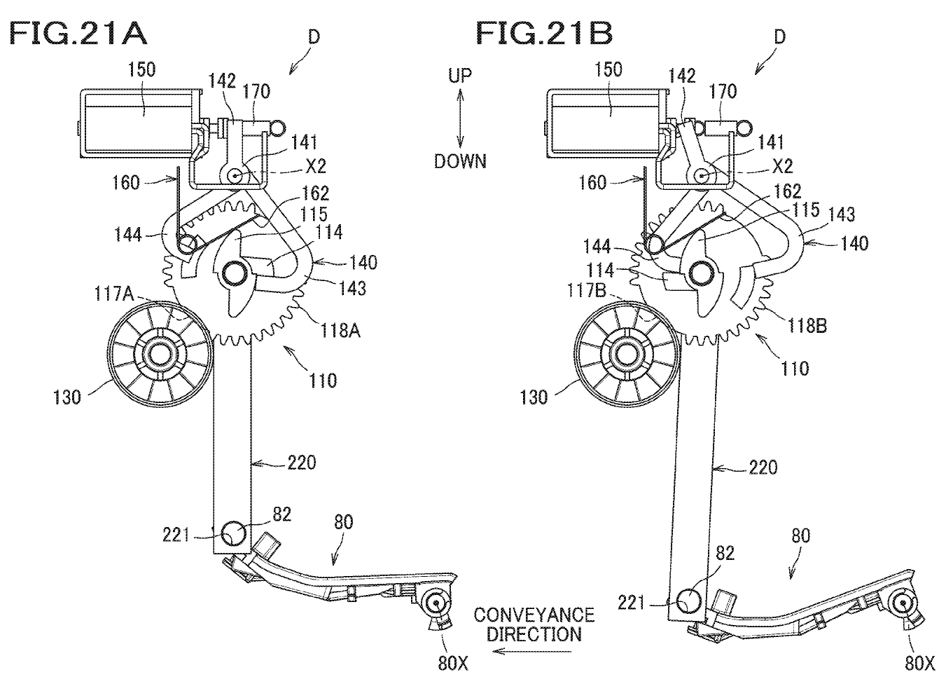

Referring to FIG. 21A and then to FIG. 21B, as the rotator 110 rotates from the first phase to the second phase, the link 220 moves downward from the first position to the second position. The link 220 thereby pushes the projection 82 of the chute 80 downward. Thus, the chute 80 moves from the first chute position to the second chute position.

Referring to FIG. 21B and then to FIG. 21A, as the rotator 110 rotates from the second phase to the first phase, the link 220 moves upward from the second position to the first position. The link 220 thereby pulls the projection 82 of the chute 80 upward. Thus, the chute 80 moves from the second chute position to the first chute position.

Next, advantageous effects of the fourth embodiment will be described.

By the link 220 being directly connected to the chute 80, the chute 80 can be held by the link 220. As a result, large movement of the chute 80 located at the first chute position or the second chute position can be suppressed. In addition, the chute 80 can be moved between the first chute position and the second chute position even in a configuration which does not include a spring that biases the chute 80 toward the first chute position.

Impacts caused by the chute 80 moving from the second chute position to the first chute position can be further reduced compared to a configuration which includes the spring that biases the chute 80 toward the first chute position. Thus, for example, distortion of unfixed toner images on the sheet S can be minimized.

Since the link 220 and the chute 80 are directly connected, the number of parts can be reduced, for example, compared to an alternative configuration in which the chute moves in conjunction with the link via another member. Thus, the mechanism for moving the chute 80 can be downsized.

Since the link 220 is directly connected to the rotator 110, the number of parts can be reduced, for example, compared to an alternative configuration in which the link moves in conjunction with the rotator via another member. Thus, the mechanism for moving the chute 80 can be downsized.

When the rotator 110 is located at the first phase, the projection 116 of the rotator 110 is located above the rotation axis X1 of the rotator 110. When the rotator 110 is located at the second phase, the projection 116 is located below the rotation axis X1 of the rotator 110. That is, the connection portion of the link 220 and the rotator 110 may be located above or below the rotation axis X1 of the rotator 110. Thus, the link 220 can be moved up and down in conjunction with the rotation of the rotator 110.

The rotator 110 is aligned with the chute 80 in the up-down direction as viewed in the widthwise direction. The chute 80 can thereby be efficiently pushed down or pulled up by the link 220 in a configuration in which the link 220 is directly connected to the chute 80.

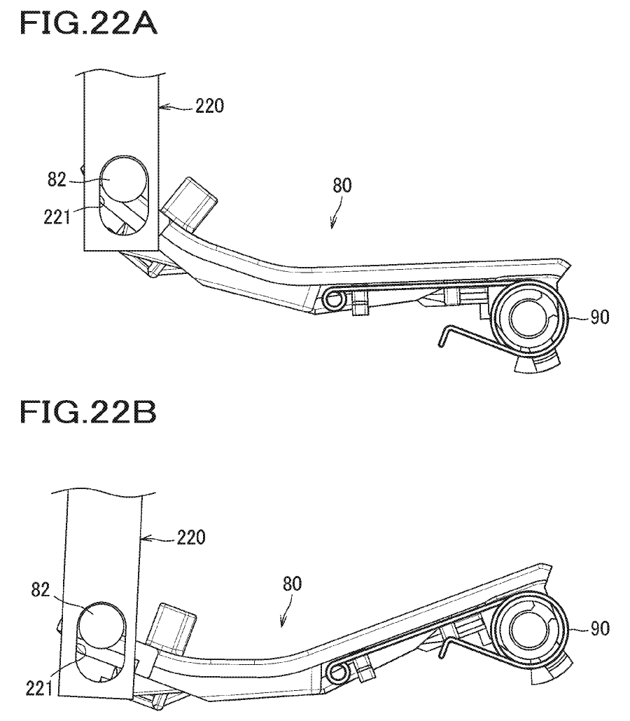

As shown in FIGS. 22A and 22B, the hole 221 in the link 220 may be an elongated hole long in the up-down direction. The projection 82 of the chute 80 is movable up and down within the hole 221, relative to the link 220. The image forming apparatus 1 may comprise helical torsion springs 90 that bias the chute 80 toward the first chute position. The helical torsion springs 90 correspond to a “second spring”.

In this configuration, the chute 80 is biased toward the first chute position by the helical torsion springs 90, and the projection 82 is thereby pressed against an upper surface of the hole 221. Thus, the chute 80 can be restrained from moving from the first chute position. The chute 80 located in the first chute position can thereby stably guide a sheet S toward the fixing position NP2. In this way, for example, the forming of wrinkles on the sheet S can be minimized.

Next, a fifth embodiment will be described.

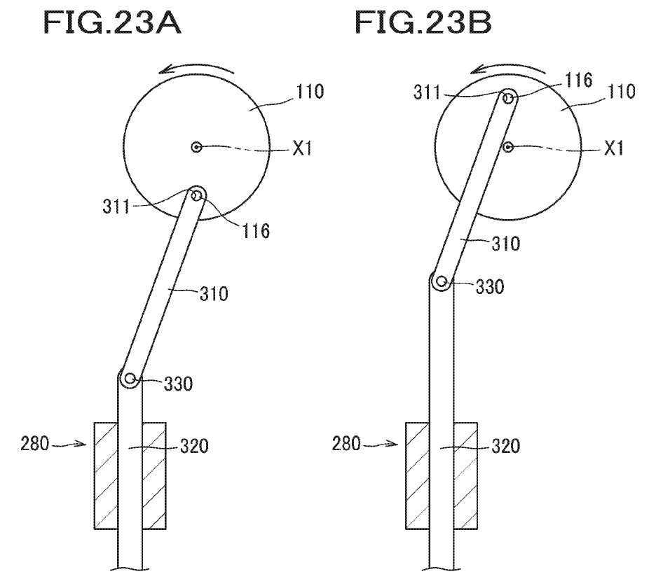

As shown in FIGS. 23A and 23B, the fifth embodiment is another configuration of a link that causes the chute 80 to move. The image forming apparatus 1 comprises a first link 310 and a second link 320. The image forming apparatus 1 comprises the second link 320 instead of the link 120 described in the first embodiment. The image forming apparatus 1 further comprises a guide 280.

An upper end of the first link 310 is directly connected to the rotator 110 in a rotatable manner. Specifically, the first link 310 has a hole 311 in the upper end thereof. The hole 311 is a hole in which the projection 116 of the rotator 110 is received. The first link 310 is connected to the rotator 110 such that the first link 310 is rotatable about the projection 116 with the projection 116 engaged with the hole 311.

The second link 320 extends in the up-down direction. The second link 320 moves in the up-down direction in conjunction with the rotation of the rotator 110 between a first position shown in FIG. 23A and a second position shown in FIG. 23B. In more detail, the second link 320 is slidable up and down between the first position and the second position.

An upper end of the second link 320 is rotatably connected to a lower end of the first link 310 via a pin 330. A lower end of the second link 320 is in contact with the projection 82 of the chute 80 from above. The first link 310 and the second link 320 are located outward, in the widthwise direction, of a sheet S conveyed over the chute 80.

The guide 280 guides the movement of the second link 320. The guide 280 extends in the up-down direction. The guide 280 guides movement of the second link 320 in the up-down direction.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the link 120 may be directly connected to the chute 80 so that the chute 80 can be pushed toward either one side or the other side in the up-down direction. As one example, the link 120 may have, at a lower end thereof, a hole into which the projection 82 of the chute 80 is received. The projection 82 traces an arcuate path as the chute 80 moves, as viewed in the widthwise direction. Therefore, the hole at the lower end of the link 120 is larger than the projection 82 as viewed in the widthwise direction, to allow the projection 82 to move within the hole relative to the link 120.

By directly connecting the link 120 to the chute 80, the chute 80 can be held by the link 120. As a result, large movement of the chute 80 located at the first chute position or the second chute position can be suppressed. In addition, the helical torsion springs 90 that bias the chute 80 toward the first chute position can be omitted. Thus, the number of parts can be reduced.

The output gear may be a gear that transmits a driving force from the motor to the photosensitive drum. The output gear may be a dedicated gear that transmits a driving force from the motor to the rotator.

The motor may be a motor for driving the heating rotator. In this case, the pressure rotator may rotate in response to rotation of the heating rotator. The motor may be a dedicated motor for driving the rotator. The motor may also be a dedicated motor for moving the chute.

The rotator may be located below the chute. The rotator need not be aligned with the chute in the up-down direction as viewed in the widthwise direction. The second phase need not be a phase rotated 180 degrees relative to the first phase.

In the above-described embodiments, the image carrier is the photosensitive drum 51; however, the image carrier may be an intermediate transfer belt or the like.

In the above-described embodiments, the pressure rotator is the pressure roller 62; however, the pressure rotator may be any object with a peripheral surface that rotates to convey a sheet. For example, the pressure rotator may be an endless pressure belt or the like. The pressure belt presses the sheet in a state where the pressure belt is sandwiched between an elastic pad facing an inside surface of the pressure belt and the heating rotator.

In the above-described embodiments, the heating rotator is the heating belt 61A; however, the heating rotator may be any object with a peripheral surface that rotates to convey a sheet. For example, the heating rotator may be a heating roller or the like.

The link may be located within a width of a sheet guided by the chute, in the widthwise direction. For example, the link may be located below the chute. The link may be configured to move in conjunction with the rotator via another member.

The solenoid actuator may be in the first state when energized and in the second state when not energized.

The chute may be configured to move in conjunction with the link via another member. The chute may be slidable between the first chute position and the second chute position. For example, the chute may be slidable between the first chute position and the second chute position in the up-down direction.

In the above-described embodiments, the first direction is the up-down direction of the image forming apparatus 1. However, the first direction may be, for example, a front-rear direction of the image forming apparatus. Further, the first direction may be, for example, a left-right direction of the image forming apparatus.

The image forming apparatus may be a printer capable of forming color images. The image forming apparatus may be a copying machine, a multifunction machine, etc. The image forming apparatus may not include the guides 180 and 280.

The elements described in the above embodiments and its modifications may be implemented selectively and in combination.

What is claimed is:

1. An image forming apparatus, comprising:
an image carrier configured to carry a toner image;
a transfer roller configured to transfer the toner image carried on the image carrier onto a sheet at a transfer position at which the transfer roller nips the sheet in combination with the image carrier;
a heating rotator configured to heat the sheet and located downstream of the transfer roller in a conveyance direction in which the sheet is conveyed;
a pressure rotator configured to apply pressure to the sheet at a fixing position at which the pressure rotator nips the sheet in combination with the heating rotator;
a chute located between the transfer position and the fixing position in the conveyance direction, and located on one side in a first direction with respect to the sheet being conveyed from the transfer position toward the fixing position, the first direction being a direction transverse to the conveyance direction, and the chute being movable between a first chute position at which the chute guides the sheet toward the fixing position and a second chute position located on the one side in the first direction relative to the first chute position;
a motor;
a rotator configured to receive a driving force from the motor and rotate; and
a link movable in the first direction, in conjunction with rotation of the rotator, between a first position at which the link locates the chute at the first chute position, and a second position at which the link locates the chute at the second chute position.

2. The image forming apparatus according to claim 1, wherein the link is directly connected to the chute and configured to push the chute toward the one side and an opposite side in the first direction.

3. The image forming apparatus according to claim 1, wherein the link is directly connected to the rotator.

4. The image forming apparatus according to claim 3, further comprising a drive mechanism configured to cause the rotator to rotate between a first phase at which the rotator locates the link at the first position and a second phase at which the rotator locates the link at the second position, the second phase being a phase rotated 180 degrees from the first phase.

5. The image forming apparatus according to claim 4, wherein
the drive mechanism comprises an output gear configured to transmit the driving force from the motor to the rotator, wherein
the rotator has on a circumferential surface thereof:
a first toothless portion;
a first gear teeth portion meshable with the output gear;
a second toothless portion; and
a second gear teeth portion meshable with the output gear,
the first toothless portion faces the output gear when the rotator is located at the first phase, and the second toothless portion faces the output gear when the rotator is located at the second phase.

6. The image forming apparatus according to claim 5, wherein the drive mechanism comprises:
a lever configured to:
stop the rotator at the first phase or the second phase upon engagement with the rotator; and
allow rotation of the rotator upon disengagement therefrom;
a solenoid actuator configured to move the lever; and
a first spring configured to apply a rotational biasing force to the rotator located at the first phase or the second phase.

7. The image forming apparatus according to claim 5, wherein the rotator is located above the chute.

8. The image forming apparatus according to claim 7, wherein a connection portion of the link and the rotator is located above a rotation axis of the rotator when the rotator is located at the first phase, and located below the rotation axis of the rotator when the rotator is located at the second phase.

9. The image forming apparatus according to claim 2, wherein
the chute has a projection protruding in the widthwise direction, and
the link has a hole in which the projection is received.

10. The image forming apparatus according to claim 9, further comprising a second spring that biases the chute toward the first chute position, wherein
the hole is an elongated hole long in the first direction.

11. The image forming apparatus according to claim 6, wherein
the lever includes:
a first arm configured to stop the rotator at the first phase upon engagement with the rotator; and
a second arm configured to stop the rotator at the second phase upon engagement with the rotator,
the lever is movable between a first lever position at which the first arm is engageable with the rotator and the second arm is not engageable with the rotator, and a second lever position at which the second arm is engageable with the rotator and the first arm is not engageable with the rotator, and
the solenoid actuator is switchable to a first state that locates the lever at the first lever position, and to a second state that locates the lever at the second lever position.

12. The image forming apparatus according to claim 11, wherein
if the solenoid actuator is switched from the first state to the second state in a state where the rotator is located at the first phase, the rotator rotates by a biasing force of the first spring, causing the first gear teeth portion to mesh with the output gear which then transmits a driving force to the rotator to rotate the rotator toward the second phase, and
the rotator engages the second arm when the rotator reaches the second phase.

13. The image forming apparatus according to claim 12, wherein
if the solenoid actuator is switched from the second state to the first state in a state where the rotator is located at the second phase, the rotator rotates by a biasing force of the first spring, causing the second gear teeth portion to mesh with the output gear which then transmits a driving force to the rotator to rotate the rotator toward the first phase, and
the rotator engages the first arm when the rotator reaches the first phase.

14. The image forming apparatus according to claim 5, wherein
the image carrier is a photosensitive drum,
the pressure rotator is a pressure roller, and
the motor is a motor that drives the photosensitive drum and the pressure roller.

15. The image forming apparatus according to claim 14, wherein the output gear is a gear configured to transmit the driving force from the motor to the pressure roller.

16. The image forming apparatus according to claim 2, wherein the rotator is aligned with the chute in the first direction, as viewed in the widthwise direction.

17. The image forming apparatus according to claim 13, further comprising a controller, wherein
the controller is configured to switch the solenoid actuator from the first state to the second state after a leading edge of the sheet passes through the fixing position.

18. The image forming apparatus according to claim 17, wherein the controller is configured to switch the solenoid actuator from the second state to the first state after a trailing edge of the sheet passes through the transfer position.

19. The image forming apparatus according to claim 4, wherein the drive mechanism comprises an electromagnetic clutch switchable to an engaged state in which the driving force from the motor is transmittable to the rotator and to a disengaged state in which the driving force from the motor is not transmitted to the rotator.

20. The image forming apparatus according to claim 1, wherein the link is located outward of the sheet conveyed over the chute in a widthwise direction of the sheet perpendicular to the conveyance direction.

21. The image forming apparatus according to claim 1, wherein the link is located outward of a sheet conveyance region of the chute in a widthwise direction of the sheet perpendicular to the conveyance direction.
